(19) United States
(12) Patent Application Publication
(10) Pub. No.: US 2003/0172215 A1
(43) Pub. Date: Sep. 11, 2003

(54) Interrupt- controller

(76) Inventors: Jorg Franke, Freiburg (DE); Joachim Ritter, Loerrach (DE)

Correspondence Address: Patrick J O'Shea, Samuels Gauthier & Stevens, 225 Franklin Street, Suite 3300, Boston, MA, 02110, US

(21) Appl. No.: 10/204,122

(22) PCT Filed: Dec. 14, 2001
(86) PCT No.: PCT/EP01/14792

(30) Foreign Application Priority Data
Dec. 16, 2000 (DE) 10062995.4

(51) Int. Cl. G06F 13/26

(52) U.S. Cl. 710/264

(57) ABSTRACT

Interrupt controller for controlling access by interrupt sources (11, 12, 13, 14) to a processor (100) and for controlling the associated branching of the current signal processing program (Rx) with a current priority (Px) in the processor. At the input end, the interrupt controller has a predetermined number of interrupt interfaces (21, 22, 23, 24) for the connection of the interrupt sources, each of the interrupt interfaces (21, 22, 23, 24) being assigned a priority value (Pi) and an address (Adi). A selection unit (30) determines from the activated interrupt interfaces the one with the highest priority value (Pmax). The through-connection of the individual interrupt interfaces (21, 22, 23, 24) to the processor (100) as an interrupt request (IR) is determined by a priority comparator (40) and a branching logic (60) which control the initiation of a context backup routine (I) in the processor (100) on the basis of the determined priority value (Pmax) and the current priority value (Px), with the branching logic determining the associated branch addresses (Vi) only toward or at the end of the currently executing context backup routine (I) so as to take into account any interrupt requests received during the context backup routine (I).

This invention relates to an interrupt controller for controlling access by a plurality of interrupt sources to a processor. The interrupt controller is to switch programs in the processor depending on which interrupt source is currently active. An example is a processor in a motor vehicle which is currently in a relatively unimportant program mode, such as control of heating and ventilation. When a temperature sensor in the engine signals overheating during that time, the processor must be rapidly switched to an engine control program, so that no damage will be caused. The case of contention in which two or more interrupt sources are sending signals for a program change at the same time is resolved by arranging that the interrupt controller connects the individual interrupt sources to the interrupt input of the processor one after the other according to predetermined priorities. To this end, each interrupt source is connected to a separate interrupt interface which is individualized by an address and a predetermined, particularly programmable, priority value. In addition, each interrupt interface is generally assigned at least two settable flags by which the interrupt controller identifies an interrupt request initiated by the interrupt source and, on the other hand, indicates to the interrupt source the enabling or disabling of the respective interrupt interface.

All interrupt interfaces are coupled to a selection unit which selects from the incoming interrupt requests the one with the highest priority. A priority comparator then compares the highest priority determined by the selection unit with the priority of the current program, and provides an interrupt request signal to the interrupt input of the processor if the requested priority is higher than the priority of the current program. If the priority is lower, the program proceeds. Since, as a rule, the processor cannot change immediately to the higher-priority program even if the interrupt request has a high priority, an exchange of request and enable signals takes place between the processor and the interrupt controller; this is commonly referred to as “handshaking”. A branching logic in the interrupt controller is fed with the priority or address of the highest-priority interrupt interface which is polled by the processor for the program branch. The branching logic generally also controls the handshaking and provides the associated signals.

In the processor, the branch instructions provided by the branching logic initiate different interrupt routines which are assigned to the respective priority of the interrupt interface to be connected to the processor, but which always include a context backup routine. During the context backup routine, the following operations are generally performed: execution of the current program in the processor is stopped, the contents of the registers in the processor core are loaded into separate memory areas, the return address to the interrupted program is determined and stored, and some flags are set or reset. In the individual portions of the respective interrupt routines, new contents, such as fixed coefficients, are read into some registers of the processor core, for example. The above-mentioned exchange of request, ready, and disabling signals between the interrupt controller and the processor ensures that the current program can only be interrupted at the points where an interruption is permitted.

The time of the data backup in the processor is not negligible. The backup takes a plurality of clock periods, e.g., between 10 and 30 clock periods, depending on the interrupt routine. During the execution of the interrupt routine, new interrupt requests can be identified at the associated interrupt interface only via the setting of the corresponding flags. The evaluation of the set flags cannot be resumed until the interrupt routine in the processor has been finished and this is indicated by corresponding signals of the branching logic. The blocking time for new interrupt requests during context backup constitutes a portion of the total blocking time, which is also referred to as “latency” and is generally assigned to the entire interrupt routine. Shortening the interrupt routine by handling the context backup and the other operations in parallel would involve major changes in the architecture of the processor and increase the circuit complexity of the latter. An interrupt controller containing those functional units is described, for example, in a data sheet of Micronas Intermetall dated Jul. 29, 1999, with the designation “CEVF-3 V3.2 Dashboard Controller-Emulator”, order number 6251-479-3PD, Section 9: “Interrupt Controller (IR) V1.5”, pages 71 to 79, cf. the block diagram of FIG. 9-1 on page 72.

It is an object of the invention to provide an interrupt controller which, in cooperation with conventional processors, has a relatively short latency.

According to the invention, this object is attained with an interrupt controller according to the preamble of claim 1 in which the branch address is delivered by or callable from the branching logic with a delay, particularly towards the end of the context backup routine initiated by the interrupt signals.

The invention and preferred embodiments thereof will now be explained in more detail with reference to the accompanying drawings, in which:

FIG. 1 is a block diagram of an interrupt controller according to the invention;

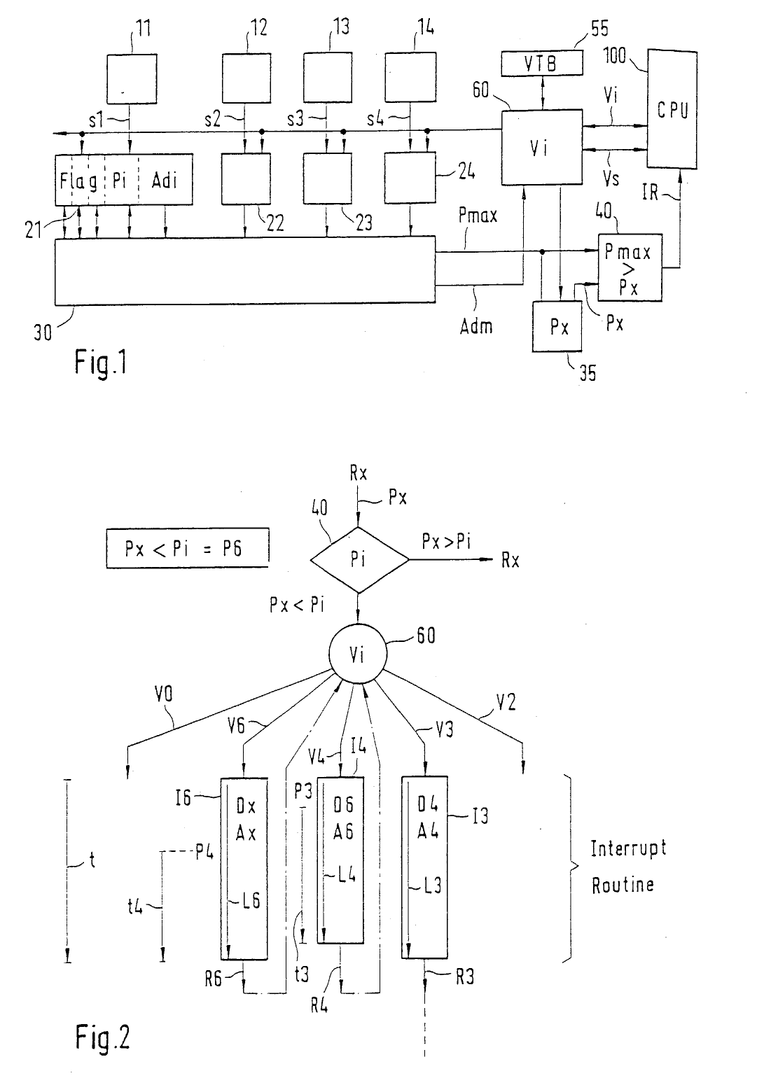

FIG. 2 shows a prior-art branching scheme;

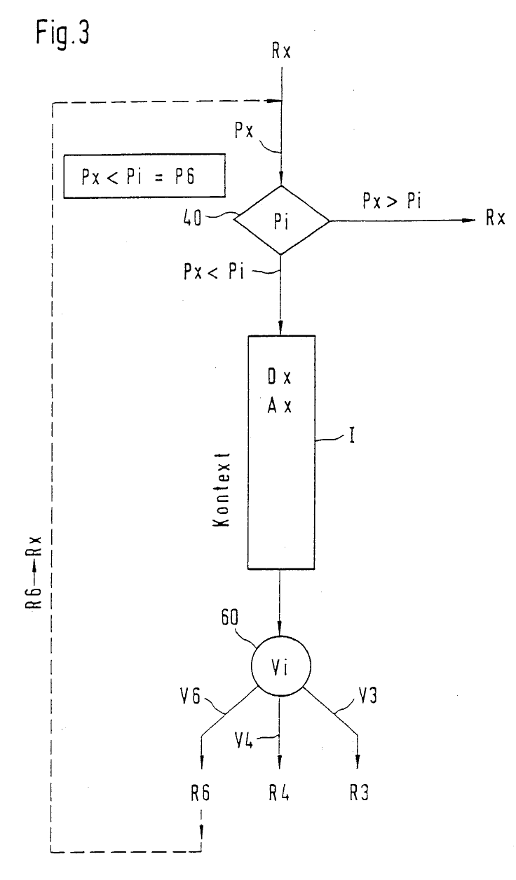

FIG. 3 shows the corresponding branching scheme according to the invention; and

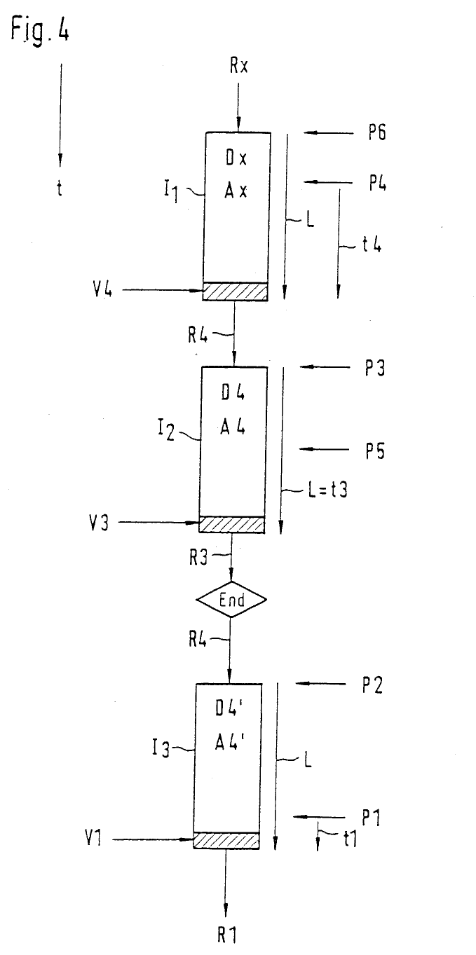

FIG. 4 is a time sequence chart showing examples of branches according to the invention.

The block diagram of FIG. 1 shows the functional blocks of an interrupt controller which will generally be implemented as a monolithic integrated circuit. FIG. 1 further shows four external interrupt sources 11, 12, 13, 14 and an external processor 100 (=CPU). The interrupt sources may be processors, transducers, or sensors which generate data or analog signals s1, s2, s3, s4 serving as switching signals for processor 100. Only four interrupt sources are shown; as a rule, however, 16 or more interrupt sources can be connected to an interrupt controller.

Associated with each interrupt source 11, 12, 13, 14 is an interrupt interface 21, 22, 23, 24 which represents the respective input circuit of the interrupt controller. The interrupt interfaces may be identical in design or differ according to the type of interrupt sources that can be connected. For identification, each interrupt interface contains its own unique address Adi and an associated priority value Pi which advantageously is programmable via a bus line (not shown). Also associated with each interrupt interface is a flag area for indicating an external interrupt request, the readiness to receive the signals sent by the interrupt source, or other states by setting the corresponding flags.

A selection unit 30 determines from the current interupt requests the one with the highest priority Pmax along with the associated address Adm. A priority comparator 40 compares this priority value Pmax with a currently valid priority value Px, and generates an interrupt request signal IR when the priority value Pmax is higher than the priority value Px. The new priority value Pmax is stored as a new current priority value Px, for instance in a register 35, in order to be available for the current priority comparison upon receipt of the next priority request. If the priority value Pmax is less than the current priority value Px, it need not be stored.

If priority comparator 40 determines that the applied priority value Pmax is higher than the current priority value Px, it will send to processor 100 an interrupt request IR which is handled there as soon as the current program Rx permits this. The handling initiates a context backup I (see FIG. 3) of the current program Rx which is identical for all priority levels, the context backup containing both the data Dx and the return address Ax to the interrupted program. Only after the context backup can the processor core be prepared for the new program; the core must, of course, be informed which of the stored programs it is to execute next. When the context backup I is finished, processor 100 notifies branching logic 60 via control signals Vs, possibly also using a handshake technique, that it now needs from the interrupt controller the necessary information about the program to be selected, or it extracts this information from branching logic 60 or from a register 55 which was previously loaded with this information by the branching logic. With this information, the processor initiates the internal branch by causing the program pointer to jump to the start address of the associated processing program.

The branching scheme of FIG. 2 shows the sequence of steps in prior-art interrupt routines in which the branch addresses are formed at the beginning of the interrupt routine. First it is assumed that a signal processing program Rx, to which the priority Px is assigned, is running in processor 100. During the signal processing program Rx, an interrupt source with the priority Pi becomes active, this priority being higher than the previous priority Px, for example If the priority Pi were lower than the previous priority Px, nothing would change in the signal processing of processor 100 and the program Rx would run on, cf. the arrow toward the right, which points to the program Rx.

In the assumed case where Pi>Px, branching logic 60 is first activated with the possible branch addresses Vi. As possible branch addresses, the addresses V0, V2, V3, V4, and V6 are given, with the smaller number indicating the higher priority. The branch address called first, V6, initiates in processor 100 an interrupt routine I6 which contains a data backup Dx of the current signal processing program Rx and a return address Ax to this program. The run duration of the interrupt routine is indicated by the time arrow t at the margin. During the interrupt routine, no new interrupt instruction can be processed. This time, as mentioned above, is referred to as latency, cf. the arrows L6, L4, L3. After the end of the interrupt routine 16, processor 100 executes the program R6. Only now can a meanwhile received interrupt request with the priority P4 be handled. In response to this interrupt request, branching logic 60 generates a branch instruction V4 which initiates the interrupt routine 14 with data backup D6 and return address A6. An interrupt request received relatively early with the higher priority P3 cannot be handled until after the time interval t3, when the interrupt routine I4 has been finished. Processor 100 then executes the signal processing program R4. Until the end of t3, the processor signaled that it was executing an uninterruptable interrupt routine. When the processor cancels this blocking signal, branching logic 60 initiates via the branch instruction V3 the interrupt program I3 with the data backup D4 and the return address R4, which is completed after the latency L3. Processor 100 then executes the program R3. This program is either serviced or interrupted by an interrupt request of higher priority, i.e., P0, P1, or P2. If the number of priority levels is less than the number of interrupt sources that can be connected, selection unit 30 can determine that on the occurrence of equal-priority interrupt requests, the request having the lesser or the greater address Adi is to be handled first.

FIG. 3 shows the branching scheme of an interrupt controller according to the invention. As in the branching scheme of FIG. 2, the starting point is a current signal processing program Rx in processor 100, to which a priority Px is assigned. On the occurrence of an interrupt request Pi with the assumed higher priority value P6, priority comparator 40 generates the interrupt request IR, which initiates a uniform context backup I of the current program Rx with data backup Dx and return address Ax. Unlike FIG. 2, the branching logic is interrogated only after the context backup I and is thus in a position to update the last valid branch address Vi until the end of the context backup I. Thus, the branching of the programs does not occur until after the context backup. In FIG. 3, the possible branch addresses V6, V4, V3 with the associated programs R6, R4, R3 are indicated. After the jump to the new program, this program is regarded as the current program Rx with the priority Px. For a newly received interrupt request from an interrupt source, the sequence begins again at the top; this is indicated in FIG. 3 by the dashed line from R6 to the start of the branching scheme.

FIG. 4 is a time sequence chart illustrating by way of example some branches in accordance with the invention. Unlike FIG. 2, the duration of the individual context backup routines I is no longer coupled to the respective priority Pi, but they are uniform routines, because processor 100 receives the corresponding branching information Vi only at the end of the context backup. Therefore, in FIG. 4, the blocking times L necessary for the context backup I are all equal, since the worst-case number of registers to be backed up must now be taken into account for the uniform context backup I. During the blocking time L of each context backup I, a data backup Dx, D4, D4′ of the respective current program Rx, R4, R4 with backup of the associated return address Ax, A4, A4′ takes place. During the blocking time L, a preparatory phase for the new program is not possible or is possible only if it is identical for all priorities. The blocking times for the individual preparatory phases follow the blocking time L for the associated context backup I but are not indicated in FIG. 4. The saving of time on the occurrence of interrupt requests is apparent from the time sequence chart of FIG. 4.

First, the current program Rx is interrupted by an interrupt request with the priority P6. The associated first context backup I₁ takes the time L. An interrupt request with the priority P4 has no effect for the time being, since the context backup I₁ continues during the time L. Only immediately prior to the end of this routine is the branching logic 60 interrogated, which determines V4 as the branch address corresponding to the subsequently received interrupt request with the priority P4. After termination of this first context backup routine I₁, processor 100 executes program R4. The time it takes until the requested program R4 becomes active is indicated by the arrow t4. With a branching scheme as shown in FIG. 2, at least the full blocking time L would be added to the time t4.

During the execution of the program R4, an interrupt request with the priority P3 occurs. Therefore, the context backup routine, the second context backup I₂, is restarted by priority comparator 40 to back up the data D4 of the current program R4 with the return address A4. During the context backup I₂, a further interrupt request with the priority P5, i.e., with a lower priority value, is received. After the context backup I₂ is completed, branching logic 60 determines the branch address V3. Processor 100 then executes the program R3, since there is no interrupt request with a higher priority. As the program R3 was preceded by a branch, at the end of this program the processor resumes the interrupted program R4, jumping to the stored return address R4 of the second context backup I₂. However, program R4 cannot be completed because during its execution, an interrupt request with the priority value P2 is received. Branching logic 60 again initiates a context backup routine, the third context backup I₃, with a data backup D4′ and a return address A4′ to the program R4. Shortly before the end of this routine I₃, a newly received interrupt request with the higher priority PI is detected. At the end of the context backup I₃, therefore, the branch address Vi is determined by branching logic 60. The processor thus executes program R1 and not program R2. The associated blocking time t1 is very short.

The late output of the branch addresses Vi is particularly advantageously achieved by modifying the contents of a register in the interrupt controller which is used as a vector table base (VTB) register and contains an address. This register, whose content is an address, is interrogated by processor 100 at the end of the context backup I, and from the modified contents, i.e., the original address and, at previously unused locations, the additional information, the processor learns which program address is to be called.

Information about the branch address Vi may also be transferred to the processor directly via suitable data links and not only indirectly via an address modification or data modification of a register controlled by the processor. Furthermore, a security facility is appropriate which determines, for instance by checking the word length or the access mode, that the data present on the data bus have nothing to do with a possible program branch. In this manner, data on the bus which are also interpretable as branching information can be detected and then blocked or rendered ineffective. Information about the access mode can be signaled via corresponding flags, for example.

Whether the individual functional units of the interrupt controller are implemented wholly or in part in hardware or software is unimportant for the realization of the invention. The specific manner of implementation is determined by optimization of the following criteria: chip area required, number of pins, processing speed, flexibility, etc.

1. An interrupt controller for controlling access by interrupt sources (11, 12, 13, 14) to a signal input of a processor (100) and for branching a program (Rx) currently running in the processor,
the interrupt controller comprising at its input end a predetermined number of interrupt interfaces (21, 22, 23, 24) for connecting the interrupt sources thereto,
wherein each interrupt interface (21, 22, 23, 24) is assigned a, particularly programmable, priority value (Pi) and an address (Adi),
wherein a selection unit (30) selects from the interrupt interfaces activated by the interrupt sources the one with the highest priority value (Pmax) and the associated address (Adm),
wherein a priority comparator (40), based on the result of a comparison between the highest priority value (Pmax) determined by the selection unit and a current priority value (Px), generates an interrupt request signal (IR) which initiates an context backup routine (I) in the processor (100), and
wherein a branching logic (60) generates a branch address (Vi) corresponding to the highest priority value (Pmax) determined by the selection unit (30),
characterized in that
the branch address (Vi) is determined by the branching logic (60) and transferred to or callable by the processor (100) only towards the end of the context backup routine, taking into account the currently highest priority value (Pmax).

2. An interrupt controller as set forth in claim 1, characterized in that, if the priority values (Pi) of the activated interrupt interfaces (21, 22, 23, 24) are equal, the selection unit (30) makes the selection on the basis of a predetermined auxiliary criteria, particularly on the basis of priorities assigned to the addresses (Adi).

3. An interrupt controller as set forth in claim 1 or 2, characterized in that the branch address (Vi) modifies the contents of a vector table base register (55), via whose address the processor (100) signals to the interrupt controller particularly the readiness for branching, in such a way that the processor can determine therefrom its own branch address necessary for program execution.

4. An interrupt controller as set forth in claim 1 or 3, characterized in that the branch address (Vi) is implemented as address modifications.

5. An interrupt controller as set forth in claim 1 or 3, characterized in that the branch address (Vi) is implemented as a data modification on a particular address.

6. An interrupt controller as set forth in any one of claims 1 to 5, characterized in that a security facility detects an erroneous output of an interrupt request (IR) or a branch address (Vi) prior to its transfer to the processor (100), so that it can be blocked or rendered ineffective.
